(19) United States
(12) Patent Application Publication
(10) Pub. No.: US 2020/0374497 A1
(43) Pub. Date: Nov. 26, 2020

(54) IMAGE DISPLAY DEVICE AND IMAGE DISPLAY METHOD

(71) Applicant: SONY CORPORATION, Tokyo (JP)

(72) Inventor: Yohei IKEZOE, Kanagawa (JP)

(73) Assignee: SONY CORPORATION, Tokyo (JP)

(21) Appl. No.: 16/766,563

(22) PCT Filed: Oct. 3, 2018
(86) PCT No.: PCT/JP2018/037066

§ 371 Date: May 22, 2020

(30) Foreign Application Priority Data
Dec. 1, 2017 (JP) 2017-231474

(51) Int. Cl. H04N 9/31

(52) U.S. Cl. CPC H04N 9/3179; H04N 9/3197; H04N 9/312

(57) ABSTRACT

An image display apparatus includes a signal identification section that identifies a signal type of an image signal input from an external apparatus, a signal processing section that performs signal processing on the input image signal for displaying an image according to a signal type on which the signal processing section is instructed, and a control section that reads information regarding the signal type at a time of past power-off from a storage section, and that instructs the signal processing section on the signal type to control the signal processing section to execute the signal processing at a time of power-on. This enables the image display apparatus such as a projector to start image display as soon as possible at a time of power-on.

### TECHNICAL FIELD

The present technology relates to an image display apparatus and an image display method and particularly relates to a technology applicable to an apparatus dealing with a plurality of image signal types.

### BACKGROUND ART

In the field of image display apparatuses such as a projector, there is a demand for starting actual display of an image as soon as possible at a time of start-up. In other words, it is desired to shorten start-up time and to start displaying an image without waiting for a long time after, for example, a user operates a power switch.

The following PTL 1 discloses a technology capable of shortening time taken before an image can be displayed since start-up.

### CITATION LIST

### Patent Literature

### [PTL 1]

JP 2017-130713A

### SUMMARY

### Technical Problems

Meanwhile, it generally takes a long time for a projector that projects and displays an image signal (moving image/still image) input from an external apparatus to perform a series of actions such as processing for initializing various devices, laser lighting-up processing, signal identification processing, and signal device setting processing after a user's operation of a power-on instruction and it, therefore, takes a long time before the input signal is displayed. It sometimes takes, for example, approximately five to ten seconds.

The signal identification processing for identifying a signal type (depending on which a resolution, a frame rate, or the like varies) of the image signal input from the external apparatus particularly causes lengthening of the time taken until display is started at the time of start-up. The reason is as follows. The signal identification processing is processing for measuring/counting a state of any of various signals such as a vertical synchronizing signal and a horizontal synchronizing signal, and the resolution and the frame rate of the input signal are determined by measuring the state for a frame time period that is a long time to some extent for reliable identification. It actually takes such time as approximately two to three seconds for measurement and identification accounting for much of the start-up time.

The present technology, therefore, provides a technology that prevents lengthening of start-up time resulting from identification of a signal type of an input signal, as much as possible.

### Solution to Problems

An image display apparatus according to the present technology includes a signal identification section that identifies a signal type of an image signal input from an external apparatus, a signal processing section that performs signal processing on the input image signal for displaying an image according to a signal type on which the signal processing section is instructed, and a control section that reads information regarding the signal type at a time of past power-off from a storage section, and that instructs the signal processing section on the signal type to control the signal processing section to execute the signal processing at a time of power-on.

As the image display apparatus for displaying an image by an image signal input from an external apparatus, there is an image display apparatus capable of performing processing to correspond to each of various signal types. The signal type means a type different in a frame rate, a resolution, and the like. Performing signal processing according to the signal type in such a way enables appropriate image display based on the input image signal. On the other hand, this makes it necessary to identify a type of the input image signal at a time of power-on, and processing time at the time of power-on is thereby lengthened. To address the problem, information regarding a signal type, for example, information regarding latest effective signal type at a time of past power-off such as at a time of previous power-off, is stored, and signal processing is tentatively started using the signal type at a time of power-on.

In the image display apparatus according to the present technology, it is conceivable that in a case in which it is possible to read latest effective information, at the time of power-on, as the signal type at the time of the past power-off from the storage section, the control section instructs the signal processing section on the signal type to control the signal processing section to start the signal processing, and further controls the signal identification section to execute identification of the signal type of the input image signal.

While the signal processing is started, at the time of power-on, using the signal type at the time of past power-off such as previous power-off, the signal type of the input image signal is not necessarily the same as the past signal type. Therefore, while the signal processing section is controlled to start signal processing, the signal identification section is controlled to execute identification of the signal type.

In the image display apparatus according to the present technology, it is conceivable that in a case in which an identification result of the signal identification section differs from the signal type on which the signal processing section is instructed, the control section instructs the signal processing section on the signal type identified by the signal identification section to control the signal processing section to start the signal processing.

In the case in which signal identification section identifies the signal type different from the signal type on which the signal processing section is already instructed, the signal processing section is controlled to execute the signal processing according to the identified signal type.

In the image display apparatus according to the present technology, it is conceivable that in a case in which it is impossible to read the latest effective information, at the time of power-on, as the signal type at the time of the past power-off from the storage section, the control section controls the signal identification section to execute the identification of the signal type of the input image signal and instructs the signal processing section on the signal type identified by the signal identification section to control the signal processing section to start the signal processing.

In the case in which it is impossible to obtain, at the time of power-on, the information regarding the signal type at the time of the past power-on, the signal identification section is controlled to execute identification of the signal type and the signal processing section is controlled to execute the signal processing using the identified signal type.

In the image display apparatus according to the present technology, it is conceivable that in a case in which it is impossible to read the latest effective information, at the time of power-on, as the signal type at the time of the past power-off from the storage section, the control section instructs the signal processing section on a signal type selected on the basis of frequency information that is information indicating an appearance frequency for the signal type to control the signal processing section to start the signal processing, and further controls the signal identification section to execute the identification of the signal type of the input image signal.

In the case in which it is impossible to obtain, at the time of power-on, the information regarding the latest effective signal type at the time of the past power-off such as the time of the previous power-off, then frequency information regarding input of each signal type as a past record is referred to, a high-frequency signal type is selected, and the signal processing section is instructed on the high-frequency signal type.

In the image display apparatus according to the present technology, it is conceivable that in a case in which it is impossible to read latest effective information, at the time of power-on, as the signal type at the time of the past power-off from the storage section, the control section instructs the signal processing section on a signal type of which the external apparatus is notified in advance to cause the signal processing section to start the signal processing, and further controls the signal identification section to execute the identification of the signal type of the input image signal.

For example, when the image display apparatus is connected to an external apparatus, the image display apparatus and the external apparatus hold communication during connection, and the image display apparatus sometimes notifies the external apparatus of, for example, a recommended signal type during the communication. In the case in which it is impossible to obtain, at the time of power-on, information regarding the latest effective signal type at the time of the past power-off, the signal processing section is instructed on the signal type of which the external apparatus is notified as described above.

In the image display apparatus according to the present technology, it is conceivable that the control section controls information regarding the signal type of the image signal identified by the signal identification section at timing of power-off to be stored in the storage section.

In other words, the signal type of the image signal last identified just before the power-off is stored as the signal type of the image signal at the time of power-off.

In the image display apparatus according to the present technology, it is conceivable that in a case in which identification of a signal type of an image signal for which an image is displayed before power-off is successful, the control section controls information regarding the signal type to be stored in the storage section.

In other words, in a case in which the signal identification section could not identify the signal type of the image signal for an image to be displayed before the power-off, the signal type is not stored in the storage section.

In the image display apparatus according to the present technology, it is conceivable that the control section controls information regarding the signal type to be stored in the storage section at a time of power-off processing.

In other words, the signal type is stored in the storage section in a course of a series of end processing at the time of power-off.

In the image display apparatus according to the present technology, it is conceivable that the control section transitions to a standby state in power-off processing, controls the signal identification section to execute signal identification in a period of time of the standby state, and controls information regarding the signal type as a signal identification result to be stored in the storage section.

In other words, while the control section is set in the standby state to correspond to the power-off operation, the signal identification and the storage of the signal type in the storage section are performed.

In the image display apparatus according to the present technology, it is conceivable that the signal identification section identifies the signal type and also performs processing for updating the frequency information according to the identification.

The signal identification section updates the frequency information indicating the appearance frequency regarding each signal type upon identifying the signal type, thereby making it possible to always provide the latest frequency information.

In the image display apparatus according to the present technology, it is conceivable that the signal identification section performs processing including count processing on an image synchronizing signal as signal type identification processing.

In other words, by performing counting for a synchronizing signal such as a vertical synchronizing signal, a horizontal synchronizing signal, or a dot clock of the image signal, processing for identifying the type such as the resolution and the frame rate is performed.

It is conceivable that the image display apparatus according to the present technology includes an image projection section that projects and displays an image on the basis of the image signal processed by the signal processing section.

In other words, the image display apparatus is configured as a projector that projects and displays an image.

An image display method according to the present technology causes an image display apparatus to execute a procedure of reading information regarding a signal type at a time of past power-off from a storage section at a time of power-on, and a procedure of causing a signal processing section that performs signal processing on an input image signal for displaying an image according to a signal type on which the signal processing section is instructed, to execute the signal processing on the basis of the signal type read from the storage section.

This increases an opportunity to be capable of correctly displaying an image without waiting for signal type identification.

Furthermore, a signal identification section that identifies a signal type of an image signal input from an external apparatus performs identification processing when and after the signal processing section starts the signal processing.

This makes it possible to deal with a case in which the signal type on which the signal processing section is instructed is not correct.

### Advantageous Effects of Invention

According to the present technology, it is possible to gain an opportunity in which appropriate display of an image can be started without waiting for signal identification processing, and to shorten start-up time (time from power-on before the image is displayed) in such a case. Particularly in an apparatus installation environment in which image signals of the same type are often input, the start-up time can be shortened in many cases.

It is noted that advantages are not necessarily limited to those described herein and may be any of the advantages described in the present disclosure.

### BRIEF DESCRIPTION OF DRAWINGS

FIG. 1 is a block diagram of a projector according to embodiments of the present technology.

FIG. 2 is an explanatory diagram of a configuration of an image projection section in the projector according to the embodiments.

FIG. 3 illustrates schematic explanatory diagrams in a case in which appropriate display of a projected image cannot be performed.

FIG. 4 illustrates flowcharts of processing at a time of power-off according to a first embodiment.

FIG. 5 is a flowchart of processing at a time of power-on according to the first embodiment.

FIG. 6 illustrates flowcharts of signal identification processing according to the embodiment.

FIG. 7 is a flowchart of processing at a time of power-on according to a second embodiment.

FIG. 8 is a flowchart of processing at a time of power-on according to a third embodiment.

FIG. 9 is a flowchart of processing at a time of power-off according to a fourth embodiment.

### DESCRIPTION OF EMBODIMENTS

Embodiments will hereinafter be described in the following order.

<1. Configuration of projector>
<2. First embodiment>
<3. Second embodiment>
<4. Third embodiment>
<5. Fourth embodiment>
<6. Conclusion and modifications>

### 1. CONFIGURATION OF PROJECTOR

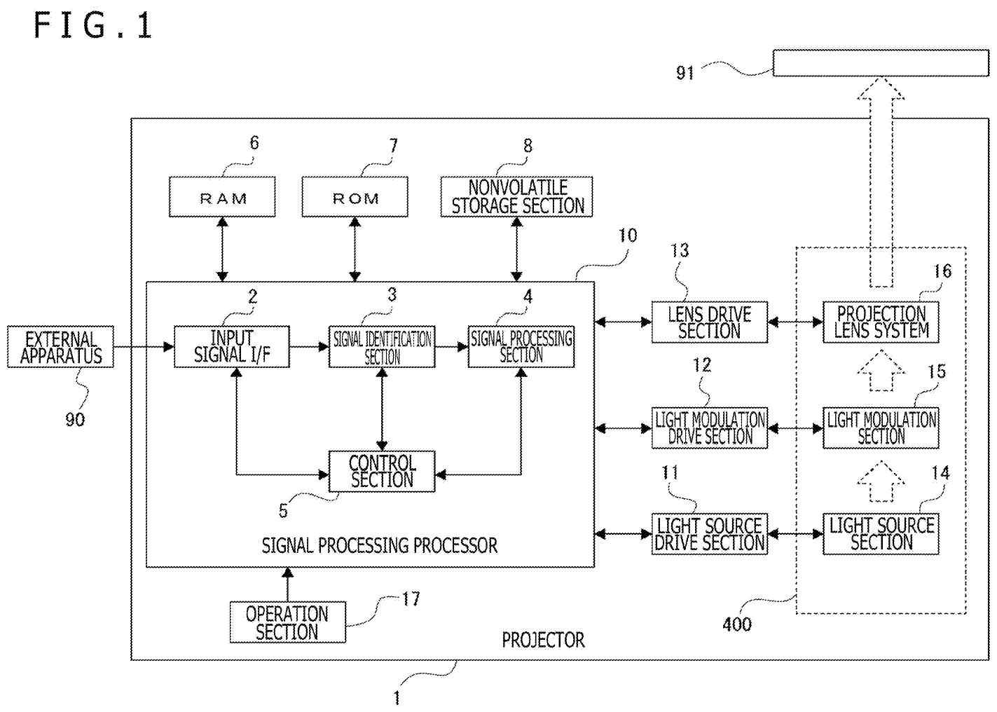

An image display apparatus will be described in embodiments while a projector 1 is taken by way of example. FIG. 1 depicts a configuration of the projector 1.

The projector 1 is an apparatus that receives an image signal supplied from an external apparatus 90 connected to the projector 1 and that projects an image onto a screen 91 to display the image. The image signal is either a still image signal or a moving image signal, and the image displayed on the screen 91 is either a still image or a moving image. Furthermore, a stereoscopic image may be displayed on the basis of an image signal in 3D (three dimensions).

It is supposed that the external apparatus 90 is an apparatus that can function as an image signal supply apparatus. It is supposed, for example, that the external apparatus 90 is a controller, a signal switcher, or the like that is connected to the projector 1 as an image signal source at a time of constructing an image projection system. Such an apparatus further selectively supplies any of image signals input from various other apparatuses to the projector 1. In this case, the external apparatus 90 may be an apparatus that converts a signal type of each image signal from each of the various apparatuses into a specific signal type and that supplies the image signal of the specific signal type to the projector 1.

Alternatively, the external apparatus 90 may be considered as an always-connected apparatus such as a video reproducing apparatus, a television tuner, or a video game machine.

Needless to say, the external apparatus 90 is possibly an apparatus that is not always connected such as a personal computer, a mobile terminal, a video reproducing apparatus, a television tuner, or a video game machine.

It is noted that the external apparatus 90 and the projector 1 may be connected by wired connection or may transmit an image signal by wireless connection.

The projector 1 includes a signal processing processor 10, a RAM (Random Access Memory) 6, a ROM (Read Only Memory) 7, a nonvolatile storage section 8, a light source drive section 11, a light modulation drive section 12, a lens drive section 13, an operation section 17, and an image projection section 400.

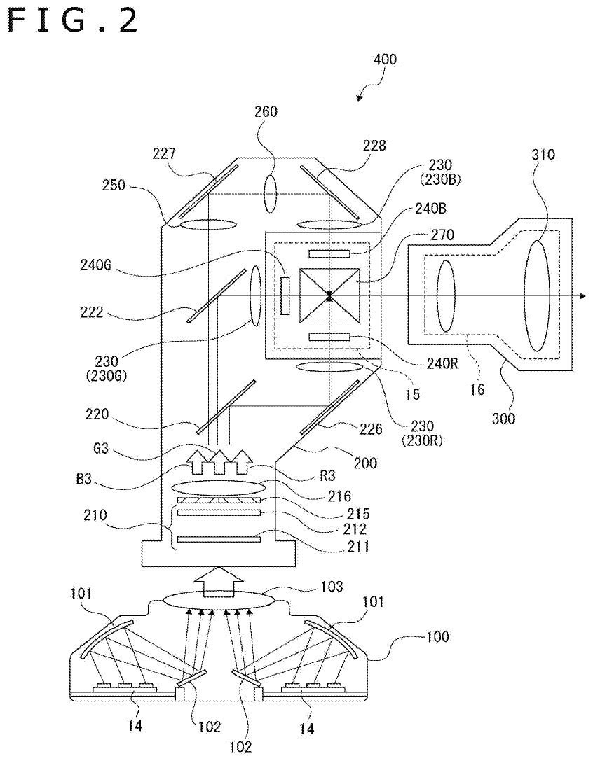

The image projection section 400 includes a light source section 14, a light modulation section 15, and a projection lens system 16, projects an image on the basis of an image signal, and displays the image on the screen 91. It is noted that an example of a structure of the image projection section 400 will be described later with reference to FIG. 2.

The image signal supplied from the external apparatus 90 is input to the signal processing processor 10.

The signal processing processor 10 includes an input signal interface 2, a signal identification section 3, a signal processing section 4, and a control section 5 as processing functions by either software or hardware, for example.

While an example in which the signal processing processor 10 includes a one-chip microcomputer, a DSP (Digital Signal Processor), or the like is described here, the input signal interface 2, the signal identification section 3, the signal processing section 4, and the control section 5 may be formed separately.

The input signal interface 2 inputs the image signal from the external apparatus 90 and performs processing for passing the image signal to the signal identification section 3 and the signal processing section 4 for signal processing.

The signal identification section 3 is a function that performs processing for identifying a signal type of the image signal input from the external apparatus 90. The projector 1 according to the embodiments is as assumed to be an apparatus capable of dealing with a plurality of signal types and displaying an image of each signal type. The signal type mentioned here indicates a difference in a signal form in which an image is configured such as a frame rate difference and a resolution difference.

To appropriately deal with the plurality of signal types, it is necessary to identify a signal type of each input image signal. That is why a function as the signal identification section 3 is provided. The signal identification section 3 identifies a frame rate and a resolution of the input image signal by measuring a vertical synchronizing signal, a horizontal synchronizing signal, a dot clock, or the like over a plurality of frames of the image signal. It is noted that this identification processing normally takes approximately two to three seconds. This is because the signal identification section 3 makes measurement over many frames in a period of time of approximately two to three seconds for improving identification accuracy.

The signal identification section 3 notifies the control section 5 of information regarding the signal type identified by the identification processing.

The signal processing section 4 is a function that performs signal processing on the input image signal to display an image according to a signal type on which the signal processing section 4 is instructed. In other words, the signal processing section 4 is instructed on the signal type by the control section 5, processes the input image signal in accordance with the frame rate and the resolution indicated by the signal type on which the signal processing section 4 is instructed, and causes image display to be executed. Specifically, the signal processing section 4 performs various types of necessary processing such as luminance processing, color processing, interpolation processing, gamma processing, contrast adjustment, sharpness adjustment, clipping of an input image to create an image to be displayed, and scaling up/down, on the input image signal, finally generates R (red), G (green), and B (blue) image data, and supplies the image data to the light modulation drive section 12. The signal processing section 4 performs such processing to be adapted to the signal type on which the signal processing section 4 is instructed.

The control section 5 controls the input signal interface 2 to input and transfer the image signal, controls the signal identification section 3 to execute processing for identifying the signal type, controls the signal processing section 4 to perform the signal processing and instructs the signal processing section 4 on the signal type, and exercises overall control over image signal processing in the signal processing processor 10.

Particularly in the present embodiments, the control section 5 performs processing for reading information regarding a signal type at a time of previous power-off from the nonvolatile storage section 8 at a time of power-on, and for instructing the signal processing section 4 on the signal type to control the signal processing section 4 to execute the signal processing, as described later.

The RAM 6 is used as a frame memory area where the image signal is temporarily stored or software (program) used by the signal processing processor 10 is deployed, and is used as work area for various kinds of computing.

Programs and fixed information for various kinds of processing by the signal processing processor 10 are stored in the ROM 7 and the nonvolatile storage section 8. Furthermore, in a case of the present embodiments, the nonvolatile storage section 8 also stores the information regarding the signal type obtained as a result of the identification performed in the identification processing by the signal identification section 3.

The operation section 17 is a region to which a user's operation is input and is operation members such as operation keys and dials provided on a casing of the projector 1 or is a touch panel apparatus using a screen as a user interface. The operation section 17 may be configured as a receiving section of a remote controller so that the operation section 17 can receive and detect a user's operation using the remote controller.

Furthermore, the operation section 17 may be configured as a camera (video input apparatus), a voice input apparatus, or the like so that the operation section 17 can sense a user's operation by a gesture or a voice.

Moreover, the operation section 17 may be configured as a communication section that receives a command from a peripheral apparatus by communication compliant with RS-232C or communication by a network (LAN: Local area network) or the like.

The operation section 17 transmits operation information detected as the user's operation to the signal processing processor 10. The control section 5 in the signal processing processor 10 performs necessary processing according to the user's operation.

The light source drive section 11 drives the light source section 14 that is a projection light source. While any of various kinds of light sources such as an LED (Light Emitting Diode), a laser light source, a xenon lamp, and a mercury lamp may be the light source section 14, the light source drive section 11 is a circuit that drives such a light source to emit light.

The light modulation drive section 12 receives the R, G, and B image data from the signal processing section 4, generates an R image signal, a G image signal, and a B image signal as liquid crystal drive signals, supplies the R image signal, the G image signal, and the B image signal to R, G, and B light valves (liquid crystal light valves 240R, 240G, and 240B to be described later) in the light modulation section 15, and causes a red image, a green image, and a blue image to be displayed.

The lens drive section 13 drives the projection lens system 16 in accordance with an instruction from the control section 5 for projected image focusing adjustment, projected image size adjustment, angle-of-projection adjustment, and the like.

FIG. 2 depicts an example of the image projection section 400 including the light source section 14, the light modulation section 15, and the projection lens system 16.

The image projection section 400 includes a light source apparatus 100, an image generation unit 200 that generates an image using light emitted from the light source apparatus 100, and a projection unit 300 that projects image light generated by the image generation unit 200.

As depicted in FIG. 2, a plurality of light source sections 14, for example, is provided within a casing of the light source apparatus 100. Light beams outgoing from the plurality of light source sections 14 are guided to a collimator lens 103 via aspherical mirrors 101 and planar mirrors 102, collimated into a generally parallel ray bundle, and incident on the image generation unit 200.

The image generation unit 200 includes an integrator element 210, a polarization conversion element 215, a condensing lens 216, dichroic mirrors 220 and 222, mirrors 226, 227, and 228, and relay lenses 250 and 260.

The image generation unit 200 also includes field lenses 230 (230R, 230G, and 230B), the liquid crystal light valves 240R, 240G, and 240B, and a dichroic prism 270. The liquid crystal light valves 240R, 240G, and 240B and the dichroic prism 270 are an example of the light modulation section 15 depicted in FIG. 1.

The integrator element 210 has a function of integrating incident light beams applied to the liquid crystal light valves 240R, 240G, and 240B from the light source apparatus 100 to have a uniform luminance distribution. The integrator element 210 includes a first fly eye lens 211 having a plurality of microlenses that is arranged in two dimensions and that is not depicted, and a second fly eye lens 212 having a plurality of microlenses that is arranged to correspond to the microlenses of the first fly eye lens 211 one by one, for example.

The parallel light incident on the integrator element 210 from the light source apparatus 100 is split into plural ray bundles by the microlenses in the first fly eye lens 211 and imaged on the corresponding microlenses in the second fly eye lens 212. The microlenses in the second fly eye lens 212 function as secondary light sources and applies a plurality of parallel light beams as incident light to the polarization conversion element 215.

The polarization conversion element 215 has a function of making the incident light beams incident via the integrator element 210 and the like have a uniform polarization state. The polarization conversion element 215 emits outgoing light containing blue light B3, green light G3, and red light R3 via, for example, the condensing lens 216 and the like disposed on an outgoing side of the light source apparatus 100.

The dichroic mirrors 220 and 222 have properties of selectively reflecting color light in a predetermined wavelength region and of transmitting light in the other wavelength regions.

For example, the dichroic mirror 220 selectively reflects the red light R3. The dichroic mirror 222 selectively reflects the green light G3 out of the green light G3 and the blue light B3 transmitted by the dichroic mirror 220.

The remaining blue light B3 is transmitted by the dichroic mirror 222. The light outgoing from the light source apparatus 100 is split into more than one color light having different colors.

The split red light R3 is reflected by the mirror 226, changed into parallel light by being passed through the field lens 230R, and then incident on the liquid crystal light valve 240R for red light modulation.

The green light G3 is changed into parallel light by being passed through the field lens 230G and then incident on the liquid crystal light valve 240G for green light modulation.

The blue light B3 is passed through the relay lens 250 and reflected by the mirror 227, and further passed through the relay lens 260 and reflected by the mirror 228. The blue light B3 reflected by the mirror 228 is changed into parallel light by being passed through the field lens 230B, and then incident on the liquid crystal light valve 240B for blue light modulation.

The liquid crystal light valves 240R, 240G, and 240B are electrically connected to the light modulation drive section 12 described above. The liquid crystal light valves 240R, 240G, and 240B modulate the incident light per pixel on the basis of the R image signal, the G image signal, and the B image signal supplied from the light modulation drive section 12, and generate the red image, the green image, and the blue image, respectively.

Each modulated color light (formed image) is incident on the dichroic prism 270 and subjected to combining. The dichroic prism 270 overlays and combines each of the color light incident from three directions, and emits the combined light to the projection unit 300.

The projection unit 300 includes the projection lens system 16 having a plurality of lenses 310 and the like, and applies the light obtained by combining performed by the dichroic prism 270 to the screen 91. A full color image is thereby displayed.

### 2. FIRST EMBODIMENT

An example of processing performed by the projector 1 configured as described above will be described as a first embodiment. The embodiment has been achieved in light of the problem with the projector 1 capable of dealing with a plurality of signal types that start-up time (time taken from a power-on operation until display an image is started) is long because of the need of the identification processing on each signal type.

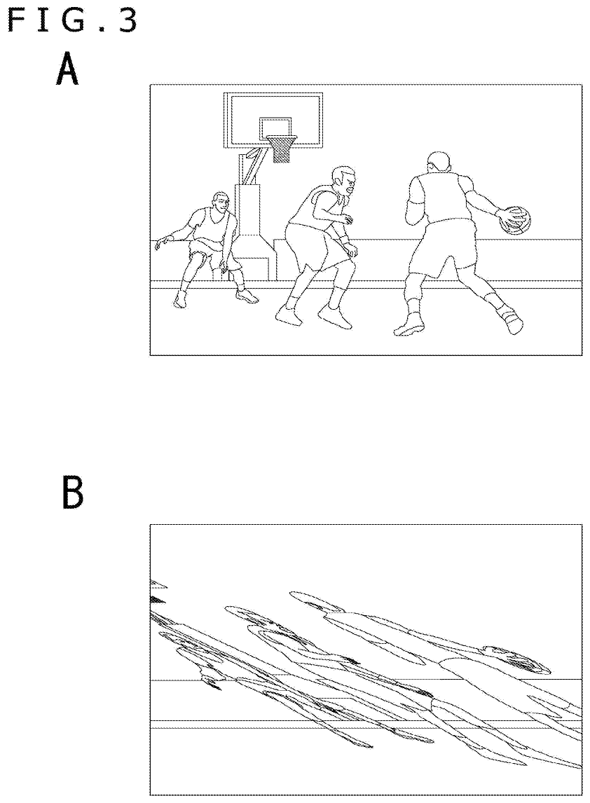

In a case in which the signal type is not accurately identified, the signal identification section 4 performs signal processing with respect to the different signal type, with the result that appropriate image display cannot be achieved. For example, in a case in which an image depicted in FIG. 3A is to be displayed, the image may be distorted as depicted in FIG. 3B or the image is furthermore turned into a state in which recognition of the image is impossible at all by performing processing in a state of a different synchronizing signal cycle and/or a different resolution.

On the other hand, there is no avoiding lengthening the start-up time if the identification processing is performed accurately on the signal type at the time of start-up.

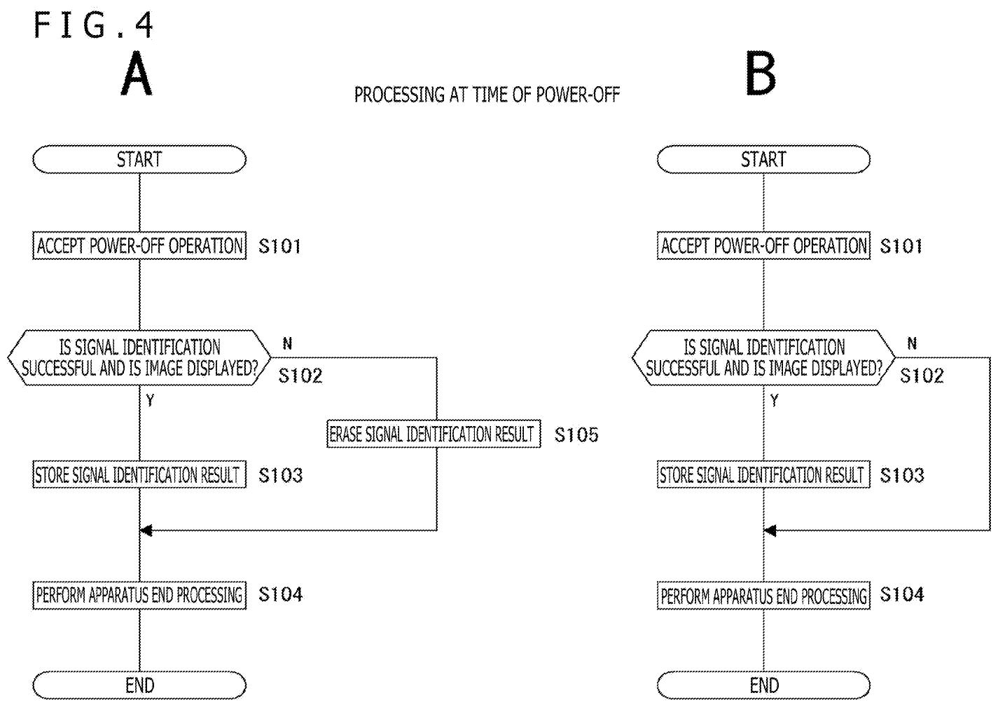

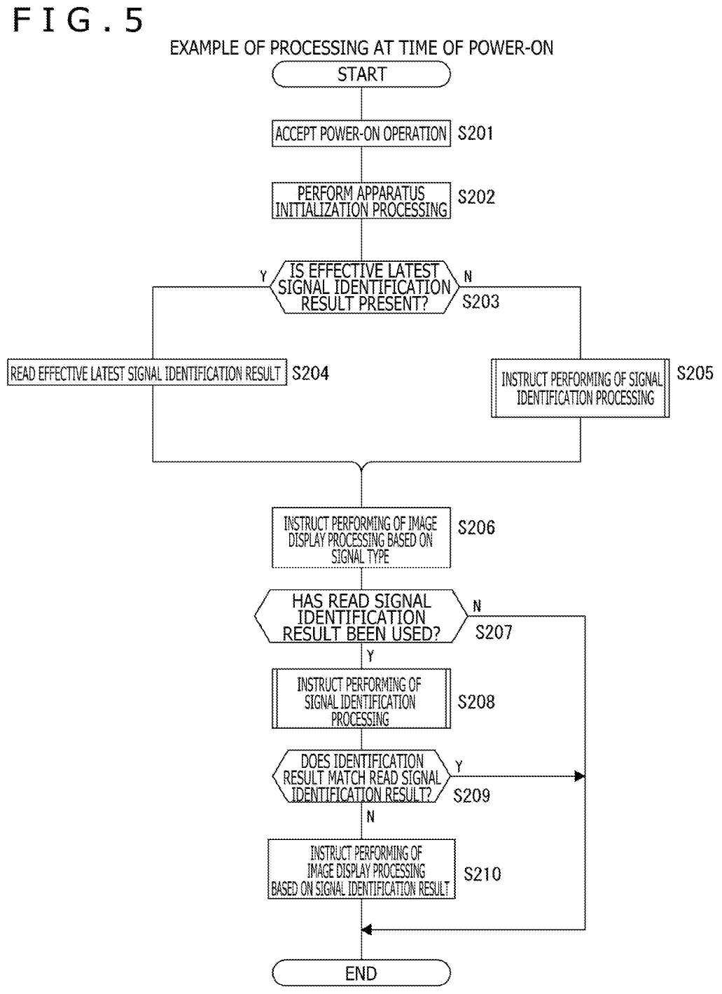

To address the problem, therefore, an opportunity in which the start-up time can be shortened is increased by causing the control section 5 to perform processing of FIGS. 4 and 5 in the first embodiment.

FIGS. 4A and 4B depict processing at a time of power-off, and FIG. 5 depicts processing at a time of power-on.

The processing at the time of power-off will first be described.

Step S101 is processing performed by the control section 5 to accept a user's power-off operation. When the user performs the power-off operation to power off the projector 1 using the operation section 17 and the control section 5 detects information regarding the operation, the control section 5 starts the processing at the time of power-off in and after Step S102.

In Step S102, the control section 5 determines whether or not the signal identification section 3 is finished with identification processing on the signal type at a point of time before the current power-off operation is performed, the signal identification is appropriately successful, and an image is displayed.

In a case of success in the signal identification processing, the control section 5 advances to Step S103, in which the control section 5 stores a result of the signal identification, that is, information indicating a signal type, in the nonvolatile storage section 8.

For example, the control section 5 defines a specific area in the nonvolatile storage section 8 as a storage area of the signal identification result (signal type), and writes the information regarding the signal type in the area in Step S103. Needless to say, a further previous signal identification result is sometimes stored in the area; however, the control section 5 overwrites the previous signal identification result with current information regarding the signal type, in the area. By doing so, when the information regarding the signal type is present in the specific area in the nonvolatile storage section 8, the information serves as a signal identification result at the latest (previous) time of power-off.

The control section 5 then advances to Step S104, in which the control section 5 performs apparatus end processing with respect to the projector 1, that is, processing necessary for power-off.

On the other hand, in a case of determining that the signal identification is not successful and an image is not displayed at timing of Step S102, the control section 5 advances to Step S105.

For example, in a case of no input image signal from the external apparatus 90 (no-signal state), in a case of a state in which signal type identification is unsuccessful and an image cannot be displayed appropriately, in a case in which signal type identification processing is not performed due to power-off right after power-on, in a case in which signal identification is successful but an image is not displayed due to the signal type with which the projector 1 is incapable of dealing, or the like, the control section 5 determines that signal identification is unsuccessful or an image is not displayed.

In these cases, the control section 5 erases information regarding the signal identification result (signal type) stored in the specific area in the nonvolatile storage section 8 in the past in Step S105, and performs the apparatus end processing in Step S104.

By performing the processing as depicted in FIG. 4A at the time of power-off, signal type information determined as an appropriate signal type of the input image signal at the current power-off timing is held in the nonvolatile storage section 8.

Furthermore, in the case of the state in which the signal type is not appropriately identified or an image is not displayed at the power-off timing, the information in the specific area in the nonvolatile storage section 8 is erased. Therefore, this processing of FIG. 4A is an example of storing the signal identification result only at a time of previous power-off, from the time of power-on to be described with reference to FIG. 5.

It is to be noted, however, that the information regarding the signal identification result held in the specific area in the nonvolatile storage section 8 is not limited to the information at the time of “previous” power-off and may be past effective signal identification results including the signal identification result at times before the previous power-off.

An example of processing of FIG. 4B is, therefore, considered applicable.

In FIG. 4B, the same processing as that in FIG. 4A is denoted by the same step number and will not be described. In this processing of FIG. 4B, in a case in which an appropriate signal identification result is not obtained at the time of power-off, the control section 5 directly advances to Step S104. In other words, the control section 5 does not perform erasure processing in Step S105 of FIG. 4A. It is noted that FIG. 4B is similar to FIG. 4A in that the control section 5 overwrites information regarding the signal identification result in the specific area in the nonvolatile storage section 8 in Step S103.

In a case of this example of processing of FIG. 4B, an effective signal identification result that is not always the signal identification result at the time of previous power-off but that a signal identification result at a time of past power-off before the previous power-off is stored at power-on timing described in FIG. 5. For example, even if an effective signal identification result is not obtained at the time of previous power-off, if an effective signal identification result is obtained at the last time but one, the effective signal identification result is stored.

By the processing at the time of power-off in either FIG. 4A or 4B described above, latest effective information is stored as the signal type at the time of past power-off in the specific area in the nonvolatile storage section 8.

In other words, the effective (and latest as a matter of course) information is stored as the signal type at the time of previous power-off in the case of FIG. 4A, while the latest effective information is stored as the signal type at the time of power-off before the previous power-off in the case of FIG. 4B.

Next, processing performed by the control section 5 at the time of power-on will be described with reference to FIG. 5.

Step S201 is processing performed by the control section 5 to accept a user's power-on operation. When the user performs the power-on operation to power on the projector 1 using the operation section 17 and the control section 5 detects information regarding the operation, the control section 5 starts processing accompanying the power-on in and after Step S202.

In Step S202, the control section 5 performs apparatus initialization processing. In other words, after a current is applied to the sections in the projector 1 as a power-on state, the control section 5 performs various kinds of initial setting to turn into a state in which the projector 1 can start operating.

In Step S203, the control section 5 confirms whether or not an latest effective signal identification result is present. The latest effective signal identification result is the information regarding the signal identification result (signal type) stored in the specific area in the nonvolatile storage section 8 in Step S103 of FIG. 4A or 4B.

If the signal identification result is stored in the specific area in the nonvolatile storage section 8, the effective signal identification result is present.

In the case in which the processing of FIG. 4A is performed and in a case, for example, in which the signal identification is not appropriately performed at the time of previous power-off, the signal identification result (signal identification result at the last time but one of power-off) stored so far in the nonvolatile storage section 8 is erased in Step S105 of FIG. 4A. Therefore, if the signal identification result is not present in the specific area in the nonvolatile storage section 8, the control section 5 can determine that an latest effective signal identification result at the latest time of power-off is not present.

Furthermore, in the case in which the processing of FIG. 4B is performed, then the latest information is stored as the signal type at the time of power-off before the previous power-off, and latest effective information is, therefore, present as the signal type at the time of previous power-off in most cases. It is noted, however, that the signal identification result is possibly erased in a case of excessive passage of time since storage; thus, a case of determining that the latest effective signal identification result is not present at the latest time of power-off possibly occurs.

In the case of presence of the latest effective signal identification result, the control section 5 advances to Step S204, in which the control section 5 reads information regarding the latest effective signal identification result (signal type) from the specific area in the nonvolatile storage section 8.

In Step S206, the control section 5 instructs the signal processing section 4 on the signal type to control the signal processing section 4 to start signal processing and also control the image projection section 400 to start image display. Therefore, image display is started without performing the signal identification processing at the time of start-up.

It is noted that the control section 5 cannot instruct the signal processing section 4 on the signal type in a case of determining in Step S203 that an latest effective signal identification result is not present. In Step S205, therefore, the control section 5 controls the signal identification section 3 to execute signal identification processing on the input image signal. The signal type of the currently input image signal is thereby identified.

After identification, the control section 5 instructs the signal processing section 4 on the identified signal type to control the signal processing section 4 to start signal processing and also control the image projection section 400 to start image display in Step S206.

This corresponds to a case in which the start-up time is lengthened due to performance of the signal identification processing at the time of start-up.

In Step S207, the control section 5 branches off the processing depending on whether or not the latest signal identification result read from the nonvolatile storage section 8 has been used this time.

In a case of instructing the signal processing section 4 to perform the signal identification processing in Step S205, the control section 5 directly ends the processing at the time of power-on and subsequently continues ordinary display control processing.

On the other hand, in a case in which the latest signal identification result read from the nonvolatile storage section 8 has been used (the control section 5 has instructed the signal processing section 4), it is not always guaranteed whether or not the signal type matches that of the input image signal.

The control section 5, therefore, advances to Step S208, in which the control section 5 instructs the signal identification section 3 to execute signal identification processing on the input image signal. The signal type of the input image signal is thereby identified.

When the signal identification section 3 is finished with the signal identification processing, the control section 5 confirms whether or not an identification result matches the latest signal identification result read from the nonvolatile storage section 8 in Step S209. In a case of matching, the control section 5 ends the processing at the time of start-up of FIG. 5 and transitions to ordinary display processing.

In a case of unmatching, the control section 5 advances to Step S210, in which the control section 5 instructs the signal processing section 4 on the signal identification result obtained in Step S208 to control the signal processing section 4 to execute image signal processing. In other words, the control section 5 instructs the signal processing section 4 that has performed so far signal processing corresponding to a fault signal type, on a correct signal type, thereby normalizing an image to be displayed on the screen 91. The control section 5 then ends the processing of FIG. 5 and subsequently performs the ordinary display control processing.

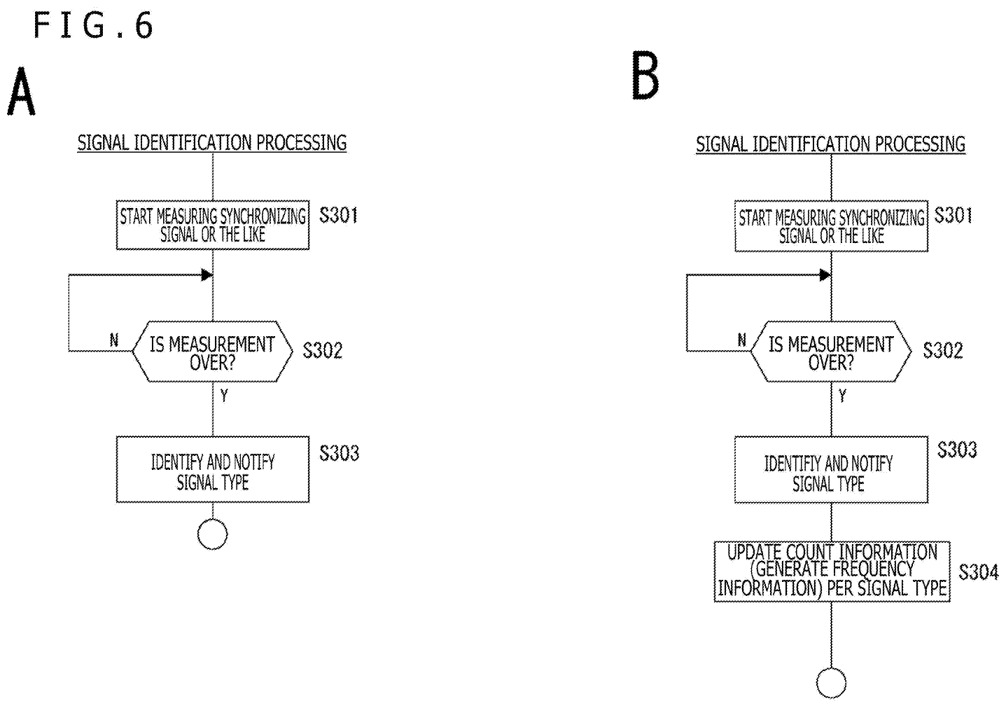

The signal identification processing executed by the signal identification section 3 according to the instruction from the control section 5 on the signal identification processing in Step S205 or S208 is performed, for example, as depicted in FIG. 6A.

The signal identification section 3 starts measuring a synchronizing signal or the like (such as a vertical synchronizing signal, a horizontal synchronizing signal, or a dot clock) in Step S301. The signal identification section 3 continues this measurement for a period of time to some extent to which it is determined that measurement is over in Step S302. When a fixed period of time or a period of time before a predetermined measurement condition is satisfied passes and it is determined that measurement is over, the signal identification section 3 advances to Step S303, in which the signal identification section 3 determines a frame rate, a resolution, and the like on the basis of a measurement result of the synchronizing signal or the like and notifies the control section 5 of this signal identification result.

By continuing measuring the synchronizing signal or the like for the period of time to some extent (for example, approximately two to three seconds) in Step S302, the signal identification section 3 can accurately determine the frame rate and the resolution.

In the first embodiment described so far, at the time of power-on, the signal processing section 4 starts the processing using the latest effective information as the signal type at the time of past power-off by the processing of FIGS. 4A (or 4B) and 5. Therefore, if the signal of the same type as the past type (for example, previous type) is supplied from the external apparatus 90, it is possible to promptly start image display after the power-on operation.

Particularly in a case of the projector 1 in the image projection system to which the signal of the same signal type as the previous signal type is normally supplied, it is possible to realize shortening of the start-up time almost every time.

While the signal identification result is described to be overwritten in the specific area in the nonvolatile storage section 8 at the time of power-off, the signal identification result may be additionally stored together with, for example, date information without overwriting the signal identification result. Any way of storing the signal identification result can be adopted as long as the past effective or latest effective signal identification result can be read.

### 3. SECOND EMBODIMENT

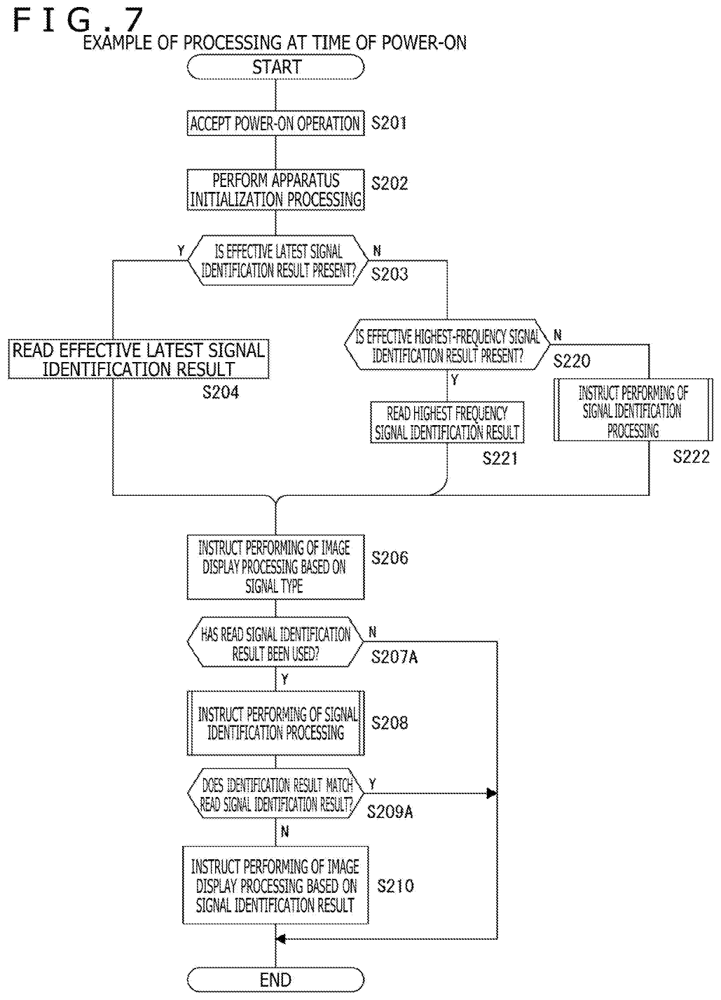

An example of processing according to a second embodiment will be described with reference to FIG. 7. It is noted that the same processing as that in FIG. 5 is denoted by the same step number to avoid repeated description.

It is assumed in the second embodiment that the processing at the time of the power-off operation is similar to that depicted in FIG. 4A or 4B. As depicted in FIG. 7, processing performed by the control section 5 at the time of the power-on operation differs from that according to the first embodiment.

In the case of the power-on operation, the control section 5 performs similar processing to that in FIG. 5 as Steps S201, S202, and S203. In the case of presence of an latest effective signal identification result, the control section 5 reads the signal identification result from the nonvolatile storage section 8 in Step S204, and instructs the signal processing section 5 on the signal type to control the signal processing section 5 to start processing and to start displaying an image in Step S206, similarly as in FIG. 5.

In the example of FIG. 7 here, in the case of determining in Step S203 that an latest effective signal identification result is not present, the control section 5 advances to Step S220, in which the control section 5 confirms whether or not an effective highest-frequency signal identification result (signal type) is present. In a case of presence, the control section 5 advances to Step S221, reads a highest-frequency signal type from the nonvolatile storage section 8 in Step S221, and instructs the signal processing section 5 on the signal type to control the signal processing section 5 to start processing and to start displaying an image in Step S206.

The highest-frequency signal identification result means here information regarding a highest-frequency signal type calculated from cumulative information regarding past signal identification results and is stored in the nonvolatile storage section 8.

By way of example, it is conceivable that the signal identification section 3 updates frequency information and stores the frequency information in the nonvolatile storage section 8 whenever performing the signal identification processing.

In a case, for example, in which the control section 5 instructs the signal identification section 3 to perform the signal identification processing, the signal identification section 3 performs processing of FIG. 6B. Steps S301, S302, and S303 are similar to those of FIG. 6A, and the signal identification section 3 identifies a current signal type and notifies the control section 5 of the identified current signal type.

In this case, the signal identification section 3 updates count information per signal type in Step S304. For example, the signal identification section 3 stores the count information per signal type in the nonvolatile storage section 8 and updates the count information in such a manner as to increment the count information corresponding to the signal type of the current identification result by one.

As a result, the count information per signal type serves as frequency information per signal type. In other words, the signal type of the highest count serves as information regarding the highest-frequency signal identification result.

It is noted that a percentage of an input opportunity per signal type, for example, may be obtained as the frequency information and that the signal type of the highest probability of input may be determined as highest-frequency information.

Furthermore, it is conceivable to adopt a scheme of leaving the information regarding the signal identification result together with an identification date as a log, obtaining the highest-frequency signal identification result from the information, and updating the highest-frequency information.

Moreover, it is possible to obtain the highest-frequency signal identification result in a past predetermined period of time if a date of each signal identification processing and each signal identification result are stored; thus, frequency information for a limited period of time, for example, the last three months, may be generated.

In the processing of FIG. 7, if an latest effective signal identification result is not present, the control section 5 confirms the information regarding the highest-frequency signal identification result, and if the information regarding the highest-frequency signal identification result is not present either, the control section 5 advances to Step S222, in which the control section 5 instructs the signal identification section 3 to perform the signal identification processing.

Furthermore, in Step S206, the control section 5 instructs the signal processing section 4 on the signal type as the signal identification result to control the signal processing section 4 to start the signal processing and displaying an image.

In Step S207A, the control section 5 branches off the processing depending on whether or not the signal identification result that is information read from the nonvolatile storage section 8 has been used as information regarding the latest signal identification result or the highest-frequency signal identification result. In a case in which the information read from the nonvolatile storage section 8 has been used, the control section 5 moves the processing to Step S208, in which the control section 5 instructs the signal identification section 3 to execute the signal identification processing.

Further, in Step S209A, the control section 5 confirms whether or not a signal type identified by the signal identification section 3 matches the signal type (effective final signal identification result or highest-frequency signal identification result) read from the nonvolatile storage section 8 and currently used. In a case of matching, the control section 5 directly ends the processing at the time of power-on of FIG. 7 and continues ordinary image display control. In a case of unmatching, the control section 5 advances to Step S210, in which the control section 5 instructs the signal processing section 4 on a current signal identification result to correct a signal processing action.

It is to be noted that, needless to say, in the case of instructing the signal processing section 4 to perform the signal identification processing in Step S222, the control section 5 is only required to end the processing at the time of power-on after Step S207A.

In the second embodiment described so far, the effective final signal identification result is basically used if the result is present, similarly to the first embodiment, but the information regarding the highest-frequency signal identification result based on the past cumulative information is used if the result is not present. Since a probability that the highest-frequency signal identification result matches the signal type of the currently input image signal is high, a possibility that an image can be correctly displayed by instructing the signal processing section 4 on the highest-frequency signal identification result is high, that is, a possibility that the start-up time can be shortened is high.

It is noted that the highest-frequency information is not limited to information simply indicating the highest count from this sense and that a signal type having a predominantly high identification count may be used as the effective highest-frequency information in a case of presence of such a signal type. In a case, for example, in which image signals of two signal types are both high in input count and in which the highest-frequency signal type is determined only by a difference in count, the possibility that the determined signal type matches that of the currently input image signal is reduced. To prevent this reduction, it is conceivable that in a case in which a probability of input of the image signal of the signal type (past input rate) is equal to or higher than 80% or the like, information regarding an effective highest-frequency signal identification result is determined to be present and used. Unless such an effective highest-frequency signal identification result is present, the control section 5 is only required to advance to Step S222 from Step S220.

### 4. THIRD EMBODIMENT

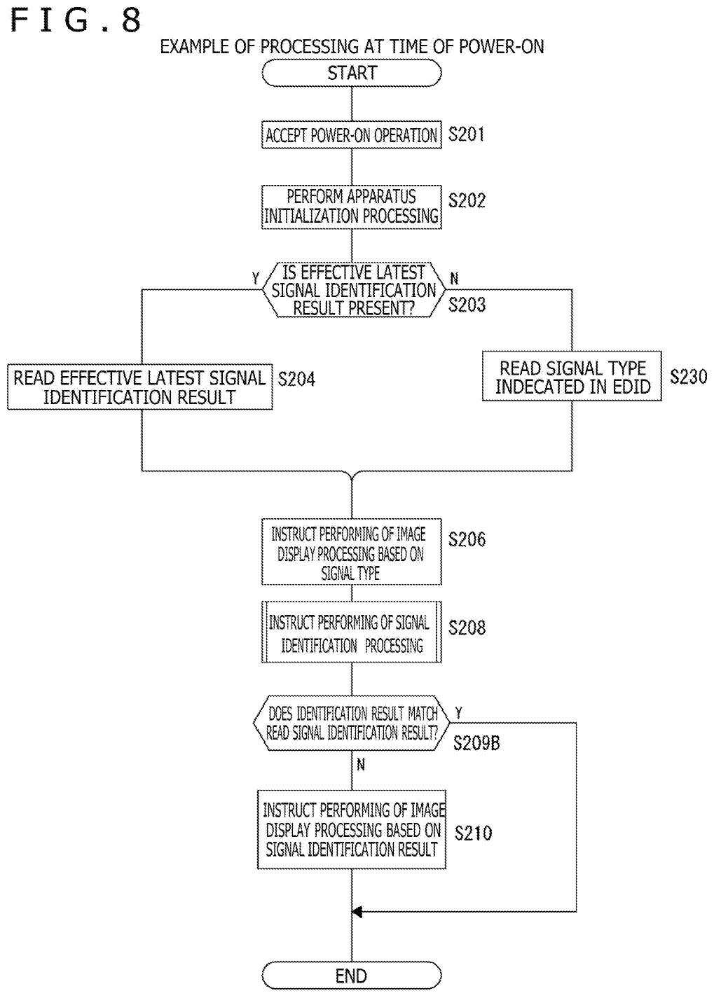

Processing performed by the control section 5 according to a third embodiment will be described with reference to FIG. 8. In FIG. 8, the same processing as that in FIG. 5 is denoted by the same step number to avoid repeated description.

It is also assumed in the third embodiment, that the processing at the time of the power-off operation is similar to that depicted in FIG. 4A or 4B. As depicted in FIG. 8, processing performed by the control section 5 at the time of the power-on operation differs from that according to the first and second embodiments.

In the case of the power-on operation, the control section 5 performs similar processing to that in FIG. 5 as Steps S201, S202, and S203. Then, in the case of presence of an latest effective signal identification result, the control section 5 reads the signal identification result from the nonvolatile storage section 8 in Step S204, and instructs the signal processing section 5 on the signal type to control the signal processing section 5 to start processing and to start displaying an image in Step S206, similarly as in FIG. 5.

In the example of FIG. 8 here, in the case of determining in Step S203 that an latest effective signal identification result is not present, the control section 5 advances to Step S230, in which the control section 5 calls information regarding a recommended signal type contained in an EDID (Extended Display Identification Data) of which the external apparatus 90 is notified. Further, in Step S206, the control section 5 instructs the signal processing section 5 on the signal type to control the signal processing section 5 to start signal processing and to start image display.

Recent electronic apparatuses are often designed to exchange various kinds of information with a counterpart electronic apparatus at a time of connecting to each other, and to mutually grasp apparatus identification information, type information, conforming standards, compatibility information, and the like. For example, information called EDID is exchanged between the projector 1 and the signal switcher or the like at the time of connection, and the projector 1 sometimes contains a recommended signal type in the EDID. There is the signal switcher that basically supplies an image signal of the recommended signal type to the projector 1 to be compatible with the projector 1.

In a case in which such a system is assumed and in which an latest effective signal identification result is not present, the control section 5 instructs the signal processing section 4 on the recommended signal type notified in the EDID as an alternative to the latest effective signal identification result, thereby making it possible to increase a possibility of performing processing/display suited for the input image signal. Therefore, it is possible to increase a possibility of shortening the start-up time before appropriate start of display.

In a case of the processing of FIG. 8, the control section 5 instructs the signal identification section 3 to perform signal identification processing for confirmation in Step S208 for the purpose of causing the signal processing section 4 to start processing using the latest effective signal identification result or the recommended signal type notified in the EDID. Further, in Step S209B, the control section 5 confirms whether or not a signal type as a signal identification result matches the signal type on which the control section 5 instructs the signal processing section 4. In a case of matching, the control section 5 directly ends the processing at the time of the power-on operation of FIG. 8 and continues ordinary image display control. In a case of unmatching, the control section 5 advances to Step S210, in which the control section 5 instructs the signal processing section 4 on a current signal identification result to correct a signal processing action.

### 5. FOURTH EMBODIMENT

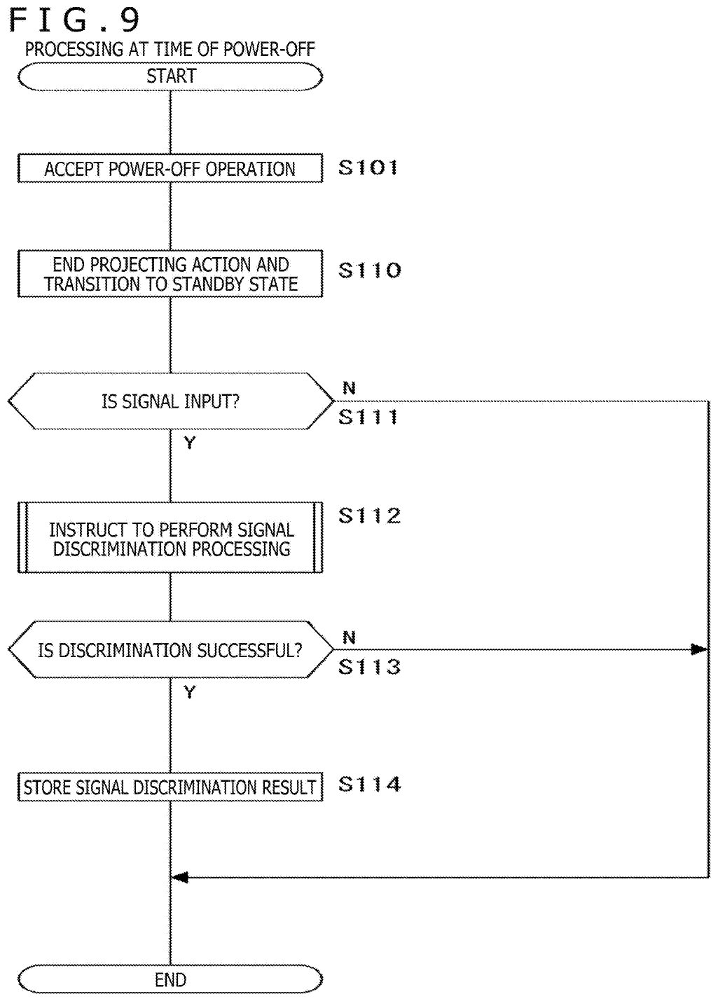

A fourth embodiment will be described with reference to FIG. 9. This is an example of the processing at the time of power-off and differs from FIG. 4A or 4B.

When accepting a user's power-off operation in Step S101, the control section 5 ends an image projecting action, performs necessary end processing, and transitions to a standby state in Step S110.

After the standby state, the control section 5 confirms whether or not an image signal is input from the external apparatus 90 in Step S111 and instructs the signal identification section 3 to perform signal identification processing in Step S112 in a case in which the image signal is input.

Further, in a case in which the signal identification section 3 is successful in identification, the control section 5 advances to Step S114 from Step S113 and instructs the signal identification section 3 to store a signal identification result in the nonvolatile storage section 8. The signal identification result is stored as, for example, an latest effective signal identification result.

In a case of confirming in Step S111 that an image signal is not input from the external apparatus 90, the control section 5 cannot instruct the signal identification section 3 to perform the signal identification processing; thus, the control section 5 ends the processing of FIG. 9 and is only kept in the standby state.

Likewise, in a case in which the signal identification section 3 is not successful in identification in Step S113, the control section 5 ends the processing of FIG. 9 without instructing the signal identification section 3 to store the latest effective signal identification result and is kept in the standby state.

It is to be noted that, in a case in which it is impossible to store the latest effective signal identification result as described above, it is conceivable that the effective signal identification result stored so far is erased or is left unerased so that the effective signal identification result can be used at a next time of power-on.

### 6. CONCLUSION AND MODIFICATIONS

While the first to fourth embodiments have been described so far, these embodiments can attain the following advantages.

A projector 1 according to the embodiments as the image display apparatus includes a signal identification section 3 that identifies a signal type of an image signal input from an external apparatus 90, and a signal processing section 4 that performs signal processing on the input image signal for displaying an image according to a signal type on which the signal processing section 4 is instructed. The projector 1 also includes a control section 5 that reads information regarding the signal type at a time of past power-off from a storage section (nonvolatile storage section 8) and that instructs the signal processing section 4 on the signal type to control the signal processing section 4 to execute the signal processing.

By so configuring the projector 1, information regarding a signal type, for example, information regarding a signal type at a time of past power-off such as at a time of previous power-off, is stored, and signal processing is started using the signal type at a time of power-on.

It is highly possible that the signal type of the input image signal after power-on is the same as that of the image signal at the time of past power-off such as at the time of previous power-off, depending on a form of use, a model, a form of connection to the external apparatus, an environment of use, and the like of the projector 1. In this case, if the signal type, for example, at the time of past power-off such as at the time of previous power-off is used at the time of start-up, there is a high possibility that an image can be displayed appropriately as it is. As a result, it is sometimes possible to shorten time taken from the power-on operation until the start of appropriate image display. It is, therefore, possible to provide the image display apparatus capable of giving an opportunity for the user to have an impression of quick start-up.

Particularly in the embodiments, the signal switcher or the controller that supplies an image signal to the projector 1 is taken as an example of the external apparatus 90. However, such an apparatus, further supplies image signals of various types input from the other apparatuses to the projector 1 upon converting the signal type of each image signal into a specific signal type.

In a case in which such a signal switcher or the like serves as the external apparatus 90 in FIG. 1, the type of the signal image in the projector 1 is the same nearly every time. Therefore, performing signal processing on the assumption of the effective signal type at the time of past power-off such as at the time of previous power-off contributes to quite a high probability that the input image signal is processed on the basis of the appropriate signal type, and to shortening the start-up time in most cases.

For example, an image projection system installed in a conference room or the like for business use or the like is used with the form of connection between the signal switcher or the like and the projector 1 remaining unchanged on a continuing basis; thus, effectiveness of the technology according to the embodiments (advantage of shortening the start-up time) is quite high.

Furthermore, it is normally assumed that the home-use projector 1 is always connected to the same video apparatus. Moreover, it is normally assumed that a signal type of an image signal output from the video apparatus is the same signal type every time. Thus, the effectiveness of the present technology is high even for the projector 1 as a general home-use projector 1.

In the first, second, and third embodiments, in a case in which it is possible to read latest effective information, at the time of power-on, as the signal type at the time of the past power-off from the nonvolatile storage section 8, the control section 5 instructs the signal processing section 4 on the signal type to control the signal processing section 4 to start the signal processing (S203, S204, and S206 in each of FIGS. 5, 7, and 8), and further controls the signal identification section 3 to execute identification of the signal type of the input image signal (S207 and S208).

While the signal processing is started, at the time of power-on, using, for example, the signal type at the time of the past power-off such as the previous power-off, using the latest effective information as the signal type at the time of the past power-off can contribute to increasing a possibility that the processing by the signal processing section 4 conforms to the signal type of the current input image signal.

However, the signal type of the input image signal is not necessarily the same as the past signal type. Therefore, while the signal processing section 4 is controlled to start signal processing, the signal identification section 3 is controlled to execute identification of the signal type.

Causing the signal identification section 3 to actually identify the signal type makes it possible to appropriately deal with a case in which an image signal of a signal type different from the signal type at the time of the past power-off is input and to identify the signal type to be different from that at the time of the past power-off.

Furthermore, the signal identification processing in this case is performed by the signal identification section 3 in a state in which the processing by the signal processing section 4 and the display are already started. Thus, if the signal type of the currently input image signal is the same as that at the time of the past power-off, the time taken until appropriate display of an image is started is not made longer.

In the first, second, and third embodiments, in a case in which an identification result of the signal identification section 3 differs from the signal type on which the signal processing section 4 is instructed after the signal processing section 4 is instructed to start processing, the control section 5 instructs the signal processing section 4 on the signal type identified by the signal identification section 3 to control the signal processing section 4 to start the signal processing (S209 and S210 in each of FIGS. 5, 7, and 8).

In other words, if it is discovered by the signal identification processing that the signal processing section 4 performing the signal processing on the input image signal on the basis of a fault signal type, the control section 5 issues a correct instruction to the signal processing section 4 so that an image can be displayed appropriately. This can realize an appropriate display state even in a case in which the image signal the signal type of which differs from that at the time of the previous power-off is input.

It is to be noted that, in this case, the time taken until appropriate display is started is relatively lengthened (by, for example, a few seconds). However, this is valuable processing in a sense that the processing prevents at least a state in which it is impossible to appropriately display an image from continuing.

In the first embodiment, in a case in which it is impossible to read the latest effective information, at the time of power-on, as the signal type at the time of the past power-off from the nonvolatile storage section 8, the control section 5 controls the signal identification section 3 to execute the identification of the signal type of the input image signal and instructs the signal processing section 4 on the signal type identified by the signal identification section to control the signal processing section 4 to start the signal processing (S203, S205, and S206 of FIG. 5).

In other words, in the case in which it is impossible to obtain the latest effective information as the signal type at the time of the past power-off, the control section 5 exercises control in such a manner that the identification of the signal type is performed first at the time of power-on and that the signal processing is started according to the identification result. This can ensure that at least display of an image can be executed regardless of a storage situation.

In the second embodiment, in a case in which it is impossible to read the latest effective information, at the time of power-on, as the signal type at the time of the past power-off from the nonvolatile storage section 8, the control section 5 instructs the signal processing section 4 on a signal type selected on the basis of frequency information that is information indicating an appearance frequency for the signal type, to control the signal processing section 4 to start the signal processing, and further controls the signal identification section 3 to execute the identification of the signal type of the input image signal (S203, S220, S221, S206, S207, and S208 of FIG. 7).

In other words, in the case in which it is impossible to obtain the latest effective information at the time of the past power-off, selecting the high-frequency signal type which has been input at a high probability so far and instructing the signal processing section on the selected signal type make it possible to increase a possibility that the selected signal type is the correct signal type again this time. Needless to say, increasing the possibility is not ensured 100°. Nevertheless, if the signal type on which the signal processing section 4 is instructed matches the signal type of the input image signal, the time taken until display of an image is started.

Furthermore, in the case in which the signal type of the currently input image signal differs from the signal type as the highest-frequency signal identification result, the signal type is changed over to a more correct signal type and the signal processing section 4 deals with the signal processing using the signal type since the more correct signal type can be obtained by the identification result of the signal identification section 3. Therefore, it is possible to ensure that at least appropriate display can be executed although it takes some time.

In the third embodiment, in a case in which it is impossible to read latest effective information, at the time of power-on, as the signal type at the time of the past power-off from the nonvolatile storage section 8, the control section 5 instructs the signal processing section 4 on a signal type of which the external apparatus is notified in advance (recommended signal type indicated by the EDID) to control the signal processing section 4 to start the signal processing, and further controls the signal identification section 3 to execute the identification of the signal type of the input image signal (S203, S230, S206, and S208 of FIG. 8).

The external apparatus 90 sometimes uses the recommended signal type of which the external apparatus 90 is notified by the receiving-side projector 1 in advance as the signal type of an image signal to be delivered. In such a system, the image signal of the recommended signal type is transmitted to the projector 1 in many cases. Therefore, instructing the signal processing section 4 on the signal type can contribute to increasing the possibility that the signal type is a correct signal type again this time. In addition, if the signal type on which the signal processing section 4 is instructed matches the signal type of the input image signal, it is possible to shorten the time taken until display is started.

While a case in which the signal type of the input image signal differs from the recommended signal type may occur, the signal type is changed over to a more correct signal type and the signal processing section 4 deals with the signal processing using the signal type since the more correct signal type can be obtained by the identification result of the signal identification section 3. Therefore, it is possible to ensure that at least appropriate display can be executed although it takes some time.

In the first embodiment, an example in which the control section 5 controls information regarding the signal type of the image signal identified by the signal identification section 3 at timing of power-off to be stored in the nonvolatile storage section 8 has been described (S102 and S103 of FIG. 4A or 4B).

In other words, the signal type of the image signal last identified just before the power-off is stored as the signal type of the image signal at the time of power-off.

In this case, the signal identification section 3 does not have to identify the signal type after the power-off operation and the signal type as a result of previous identification (for example, the signal identification result obtained in S205 and S208 at the time of power-on) is only required to be stored; thus, the time of power-off processing is not lengthened.

In the example of the processing at the time of power-off of FIG. 4A or 4B described in the first embodiment, in a case in which identification of a signal type of an image signal for which an image is displayed before power-off is successful, the control section 5 controls information regarding the signal type to be stored in the nonvolatile storage section 8 (S102 and S103).

In other words, in a case in which the signal identification section could not identify the signal type of the image signal for an image displayed before the power-off, the latest effective signal identification result is not stored in the nonvolatile storage section 8. This can prevent uncertain information regarding the signal type from being referred to at a time of next power-on.

In the example of processing of FIG. 4A or 4B described in the first embodiment, the control section 5 controls information regarding the signal type to be stored in the nonvolatile storage section 8 at a time of power-off processing.

In other words, the signal type is stored in the storage section in a course of a series of end processing at the time of power-off.

By doing so, storage of the signal type is executed at the time of power-off as a preparation for the time of next power-on, and the signal type can be appropriately referred to at the time of next power-on.

In the fourth embodiment, the control section 5 transitions to a standby state in power-off processing, controls the signal identification section 3 to execute signal identification in a period of time of the standby state, and controls information regarding the signal type as a signal identification result, to be stored in the nonvolatile storage section 8.

This makes it possible to perform the signal identification processing during standby after the power-off, that is, when there is time to spare.

In the second embodiment, as described with reference to FIG. 6B, the signal identification section 3 identifies the signal type and also performs processing for updating the frequency information according to the identification.

The signal identification section updates the frequency information indicating the appearance frequency of each signal type upon identifying the signal type, thereby making it possible to provide the latest frequency information.

It is thereby possible to select the signal type on the basis of the latest frequency information at the time of power-on.

It is noted that various specific examples of the frequency information are conceivable. Examples of the frequency information to be supposed include a cumulative total appearance frequency of each signal type, an appearance frequency in a most recent predetermined period of time, an appearance rate of each signal type in all signal types, and an appearance rate in the most recent predetermined period of time.

Particularly using the appearance frequency or appearance rate in the most recent predetermined period of time makes it possible to facilitate selecting a signal type that is recently input frequently as the high-frequency signal type according to a recent change in the external apparatus 90, a change in the form of connection between the external apparatus 90 and the projector 1, a change in the environment of use, or the like, and to increase the possibility of correct selection.

It is noted that storing the identification result of the signal type together with information regarding a date of identification makes it possible to obtain the frequency while narrowing down the period of time in more detail. Furthermore, it is possible to generate, for example, frequency information regarding each day of week, and it is conceivable to make it possible to select the high-frequency signal type on the day of week corresponding to the relevant day.

In the embodiments, the signal identification section 3 performs processing including count processing on an image synchronizing signal as signal type identification processing (S301 of FIGS. 6A and 6B).

In other words, by performing counting for a synchronizing signal such as a vertical synchronizing signal, a horizontal synchronizing signal, or a dot clock of the image signal, processing for identifying the type such as the resolution and the frame rate is performed.

In a case of the processing including counting synchronizing signals in such a way, there is no avoiding lengthening time. In the embodiments, display processing is performed using the signal type at the time of previous power-off before such signal type identification processing is completed. Therefore, an advantage is high if the time taken until display is shortened (while the current signal type is the same as the signal type at the time of previous power-off).

In the embodiments, an example of the apparatus including an image projection section 400 that projects and displays an image on the basis of the image signal processed by the signal processing section 4 has been described as the projector 1.

By applying the technology according to the embodiments, the time taken until projection and display are started when the projector 1 starts up.

It is noted that various examples such as a floor-standing type and a ceiling-suspended type are conceivable as a type of the projector 1.

It is noted that modifications and application examples of the present technology are not limited to those exemplarily described in the embodiments and that various modifications and application examples are conceivable.

In the embodiments, in the case in which the latest effective signal identification result is stored in the nonvolatile storage section 8, information regarding the signal identification result is used. By contrast, the information regarding the highest-frequency signal identification result may be confirmed first and the signal processing section 4 may be instructed on the highest-frequency signal identification result if the information is present.

Furthermore, an example of processing such that the projector 1 always starts up using the recommended signal type indicated by notification of the EDID is similarly conceivable.

The technology described in the embodiments is also applicable to image display apparatuses other than the projector 1. For example, the image display apparatus may be a television monitor apparatus, a monitor apparatus for an information processing terminal, or the like. If the image display apparatus includes an external input and is capable of dealing with various signal types of input image signal, in particular, the present technology is suited regardless of a form the image display apparatus.

It is noted that the advantages described in the present specification are given as an example only, and the advantages are not limited to those described in the present specification and may contain other advantages.

The present technology can also be configured as follows.

(1)

An image display apparatus including:

a signal identification section that identifies a signal type of an image signal input from an external apparatus;

a signal processing section that performs signal processing on the input image signal for displaying an image according to a signal type on which the signal processing section is instructed; and

a control section that reads information regarding the signal type at a time of past power-off from a storage section, and that instructs the signal processing section on the signal type to control the signal processing section to execute the signal processing at a time of power-on.

(2)

The image display apparatus according to (1), in which

in a case in which it is possible to read latest effective information, at the time of power-on, as the signal type at the time of the past power-off from the storage section, the control section instructs the signal processing section on the signal type to control the signal processing section to start the signal processing, and further controls the signal identification section to execute identification of the signal type of the input image signal.

(3)

The image display apparatus according to (2), in which

in a case in which an identification result of the signal identification section differs from the signal type on which the signal processing section is instructed, the control section instructs the signal processing section on the signal type identified by the signal identification section to control the signal processing section to start the signal processing.

(4)

The image display apparatus according to (2) or (3), in which

in a case in which it is impossible to read the latest effective information, at the time of power-on, as the signal type at the time of the past power-off from the storage section, the control section controls the signal identification section to execute the identification of the signal type of the input image signal and instructs the signal processing section on the signal type identified by the signal identification section to control the signal processing section to start the signal processing.

(5)

The image display apparatus according to (2) or (3), in which

in a case in which it is impossible to read the latest effective information, at the time of power-on, as the signal type at the time of the past power-off from the storage section, the control section instructs the signal processing section on a signal type selected on the basis of frequency information that is information indicating an appearance frequency for the signal type, to control the signal processing section to start the signal processing, and further controls the signal identification section to execute the identification of the signal type of the input image signal.

(6)

The image display apparatus according to (2) or (3), in which

in a case in which it is impossible to read latest effective information, at the time of power-on, as the signal type at the time of the past power-off from the storage section, the control section instructs the signal processing section on a signal type of which the external apparatus is notified in advance to control the signal processing section to start the signal processing, and further controls the signal identification section to execute the identification of the signal type of the input image signal.

(7)

The image display apparatus according to any one of (1) to (6), in which

the control section causes information regarding the signal type of the image signal identified by the signal identification section at timing of power-off to be stored in the storage section.

(8)

The image display apparatus according to any one of (1) to (6), in which

in a case in which identification of a signal type of an image signal for which an image is displayed before power-off, is successful, the control section causes information regarding the signal type to be stored in the storage section.

(9)

The image display apparatus according to any one of (1) to (8), in which

the control section causes information regarding the signal type to be stored in the storage section at a time of power-off processing.

(10)

The image display apparatus according to any one of (1) to (8), in which

the control section transitions to a standby state in power-off processing, controls the signal identification section to execute signal identification during a period of time of the standby state, and controls information regarding the signal type as a signal identification result to be stored in the storage section.

(11)

The image display apparatus according to (5), in which

the signal identification section identifies the signal type and also performs processing for updating the frequency information according to the identification.

(12)

The image display apparatus according to any one of (1) to (11), in which

the signal identification section performs processing including count processing on an image synchronizing signal as signal type identification processing.

(13)

The image display apparatus according to any one of (1) to (12), further including:

an image projection section that projects and displays an image on the basis of the image signal processed by the signal processing section.

(14)

An image display method causing an image display apparatus to execute:

a procedure of reading information regarding a signal type at a time of past power-off from a storage section at a time of power-on; and

a procedure of causing a signal processing section that performs signal processing on an input image signal for displaying an image according to a signal type on which the signal processing section is instructed, to execute the signal processing on the basis of the signal type read from the storage section.

(15)

The image display method according to (14), wherein

a signal identification section that identifies a signal type of an image signal input from an external apparatus performs identification processing when and after the signal processing section starts the signal processing.

### REFERENCE SIGNS LIST

1 . . . Projector, 2 . . . Input signal interface, 3 . . . Signal identification section, 4 . . . Signal processing section, 5 . . . Control section, 6 . . . RAM, 7 . . . ROM, 8 . . . Nonvolatile storage section, 10 . . . Signal processing processor, 11 . . . Light source drive section, 12 . . . Light modulation drive section, 13 . . . Lens drive section, 14 . . . Light source section, 15 . . . Light modulation section, 16 . . . Projection lens system, 17 . . . Operation section, 90 . . . External apparatus, 91 . . . Screen, 100 . . . Light source apparatus, 200 . . . Image generation unit, 300 . . . Projection unit, 400 . . . Image projection section

1. An image display apparatus comprising:
a signal identification section that identifies a signal type of an image signal input from an external apparatus;
a signal processing section that performs signal processing on the input image signal for displaying an image according to a signal type on which the signal processing section is instructed; and
a control section that reads information regarding the signal type at a time of past power-off from a storage section, and that instructs the signal processing section on the signal type to control the signal processing section to execute the signal processing at a time of power-on.

2. The image display apparatus according to claim 1, wherein
in a case in which it is possible to read latest effective information, at the time of power-on, as the signal type at the time of the past power-off from the storage section, the control section instructs the signal processing section on the signal type to control the signal processing section to start the signal processing, and further controls the signal identification section to execute identification of the signal type of the input image signal.

3. The image display apparatus according to claim 2, wherein
in a case in which an identification result of the signal identification section differs from the signal type on which the signal processing section is instructed, the control section instructs the signal processing section on the signal type identified by the signal identification section to control the signal processing section to start the signal processing.

4. The image display apparatus according to claim 2, wherein
in a case in which it is impossible to read the latest effective information, at the time of power-on, as the signal type at the time of the past power-off from the storage section, the control section controls the signal identification section to execute the identification of the signal type of the input image signal and instructs the signal processing section on the signal type identified by the signal identification section to control the signal processing section to start the signal processing.

5. The image display apparatus according to claim 2, wherein
in a case in which it is impossible to read the latest effective information, at the time of power-on, as the signal type at the time of the past power-off from the storage section, the control section instructs the signal processing section on a signal type selected on a basis of frequency information that is information indicating an appearance frequency for the signal type, to control the signal processing section to start the signal processing, and further controls the signal identification section to execute the identification of the signal type of the input image signal.

6. The image display apparatus according to claim 2, wherein
in a case in which it is impossible to read latest effective information, at the time of power-on, as the signal type at the time of the past power-off from the storage section, the control section instructs the signal processing section on a signal type of which the external apparatus is notified in advance to control the signal processing section to start the signal processing, and further controls the signal identification section to execute the identification of the signal type of the input image signal.

7. The image display apparatus according to claim 1, wherein
the control section causes information regarding the signal type of the image signal identified by the signal identification section at timing of power-off to be stored in the storage section.

8. The image display apparatus according to claim 1, wherein
in a case in which identification of a signal type of an image signal for which an image is displayed before power-off, is successful, the control section causes information regarding the signal type to be stored in the storage section.

9. The image display apparatus according to claim 1, wherein
the control section causes information regarding the signal type to be stored in the storage section at a time of power-off processing.

10. The image display apparatus according to claim 1, wherein
the control section transitions to a standby state in power-off processing, controls the signal identification section to execute signal identification during a period of time of the standby state, and controls information regarding the signal type as a signal identification result to be stored in the storage section.

11. The image display apparatus according to claim 5, wherein
the signal identification section identifies the signal type and also performs processing for updating the frequency information according to the identification.

12. The image display apparatus according to claim 1, wherein
the signal identification section performs processing including count processing on an image synchronizing signal as signal type identification processing.

13. The image display apparatus according to claim 1, further comprising:
an image projection section that projects and displays an image on a basis of the image signal processed by the signal processing section.

14. An image display method causing an image display apparatus to execute:
a procedure of reading information regarding a signal type at a time of past power-off from a storage section at a time of power-on; and
a procedure of causing a signal processing section that performs signal processing on an input image signal for displaying an image according to a signal type on which the signal processing section is instructed, to execute the signal processing on a basis of the signal type read from the storage section.

15. The image display method according to claim 14, wherein
a signal identification section that identifies a signal type of an image signal input from an external apparatus performs identification processing when and after the signal processing section starts the signal processing.
